(19) United States
(12) Patent Application Publication
(10) Pub. No.: US 2008/0193193 A1
(43) Pub. Date: Aug. 14, 2008

(54) Multi-unit cosmetic applicator

(76) Inventors: Andrew H. Pechko, Ridgewood, NJ (US); John S. Kurek, Goshen, NY (US)

Correspondence Address: Charles J. Zeller Esq.;Avon Products Inc., Avon Place, Suffern, NY, 10901, US

(21) Appl. No.: 11/818,027

(22) Filed: Jun. 13, 2007

Related U.S. Application Data
(60) Provisional application No. 60/900,369, filed on Feb. 8, 2007.

(51) Int. Cl. A45D 40/10; A45D 40/02; B43K 27/00

(52) U.S. Cl. 401/81; 401/87

(57) ABSTRACT

A multi-unit cosmetic applicator comprising: a housing body, a first cosmetic unit housed in the housing body, a second cosmetic unit housed in the housing body, an opening in the housing, wherein each cosmetic unit has a means for being independently movable relative to each other from a stored position to an advanced position and back to its stored position.

### BACKGROUND OF THE INVENTION

The present invention relates to applicators for applying a product to the body of the consumer; in particular, to a cosmetic applicator having at least multiple cosmetic units wherein one unit is independently movable with respect to the other units.

### DISCUSSION OF THE PRIOR ART

Cosmetic applicators are designed to deliver a cosmetic agent such as lip gloss, mascara, lip liner, concealer, foundation, eye shadow and eyeliner, etc from a cosmetic unit. The cosmetic unit may be a solid, a liquid reservoir, or the like. Due to ease of design and manufacturing, applicators typically house only one cosmetic unit.

Thus, users must carry a variety of applicators. For example, when applying a lip gloss, it might be useful to also have a lip liner available. Thus, the user must remember to carry both items. This, of course, requires the number of items to carry and reduces the space needed to carry the items.

A need, therefore, exists for a simpler and easier to use cosmetic applicator that also avoids the known shortcomings of only having one cosmetic unit in a housing.

Even when a user carries all items with them, it may be that the cosmetic agents being used are incompatible. In the example above, the lip gloss may include ingredients that react adversely with the lip liner. The conflict may be relatively minor, liquefaction or smearing of one or the other cosmetic agent, to serious, burning or allergic reactions on the user's skin.

Thus, a further need exists for the delivery of cosmetic agents that are compatible with each other. Since cosmetic agents may have different physical states, typically liquid, solid, or amorphous, a need exists for the cosmetic applicator to deliver such compatible cosmetic agents in their state.

### SUMMARY OF THE INVENTION

The needs are met by the present invention. Therein, a cosmetic applicator for dispensing at least a first and a second cosmetic agent on the skin of a user comprises housing having an inner space, a first cosmetic unit comprising the first cosmetic agent disposed in the housing, a second cosmetic unit comprising the second cosmetic agent disposed in the housing, and a means for advancing the second cosmetic unit relative to the first cosmetic unit from a stored position to an advanced position.

The means for advancement may be a slide assembly, a twist assembly, and/or a push button and spring assembly.

### BRIEF DESCRIPTION OF THE DRAWINGS

The above and other features and advantages will become more readily apparent from a detailed description taken in conjunction with the following drawings, in which:

FIGS. 1a and 1b are front perspective views of a multi-unit cosmetic applicator in accordance with a first embodiment of the invention.

FIGS. 2a-2c are, respectively, a right-side view of a multi-unit cosmetic applicator in accordance with the first embodiment of the present invention, a front view of a dual cosmetic applicator thereof and a cross-sectional view of a dual cosmetic applicator thereof taken along line B-B of FIG. 2b.

FIGS. 3a and 3b are perspective views of a multi-unit cosmetic applicator in accordance with the second embodiment of the invention.

FIGS. 4a-4c are, respectively, a front view of multi-unit cosmetic applicator of the second embodiment of the present invention in an advanced position, a cross-sectional view of a dual cosmetic applicator thereof taken along line A-A of FIG. 4a, and a see-through view of a dual cosmetic applicator thereof in an advanced position.

FIGS. 5a and 5b are front perspective views of a multi-unit cosmetic applicator in accordance with third embodiment of the invention.

FIGS. 6a-6c are, respectively, a right-side view of multi-unit cosmetic applicator of the third embodiment of the present invention, a front view of a dual cosmetic applicator thereof, and a cross-sectional view of a multi-unit cosmetic applicator taken along line A-A of FIG. 6b.

FIGS. 7a and 7b are front perspective views of a multi-unit cosmetic applicator in accordance with a fourth embodiment of the invention.

FIG. 8 is a cross-sectional view of the multi-unit cosmetic applicator thereof.

FIGS. 9a and 9b are top perspective views thereof.

FIGS. 10a and 10b are, respectively, a right-side perspective view and a left-side perspective view, as of a multi-unit cosmetic applicator in accordance with a further embodiment of the invention.

FIGS. 11a and 11b are, respectively, a front perspective view and a top view of multi-unit cosmetic applicator.

FIGS. 12a-12e are, respectively, a right-side view of multi-unit cosmetic applicator, a side partial see-through view of multi-unit cosmetic applicator, a top partial see-through view of multi-unit cosmetic applicator, a cross-sectional view of dual cosmetic applicator taken along line A-A of FIG. 12a, and a partial see-through view of a detail of area B of FIG. 12a.

### DETAILED DESCRIPTION OF THE INVENTION

Herein, “cosmetic agent” is used to denote the cosmetic that is applied to the user, while “cosmetic unit” is used to designate the physical formation that includes the cosmetic agent. For example, the lipstick components that are used to cover and/or enhance the lips of the user are the cosmetic agent, while the molded, typically cylindrical, form of the lipstick transported and used from the applicator is the cosmetic unit. Similarly, the liquid in a reservoir would be the cosmetic agent, while the reservoir is the cosmetic unit. One skilled in the art would understand the above not to be an exhaustive list.

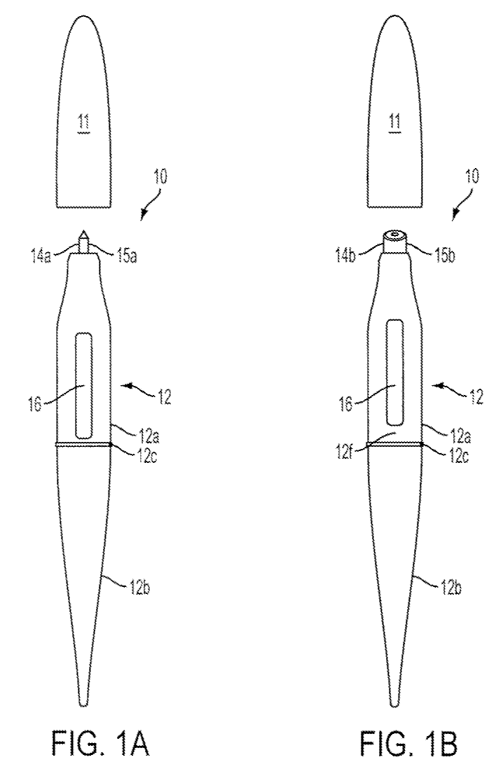

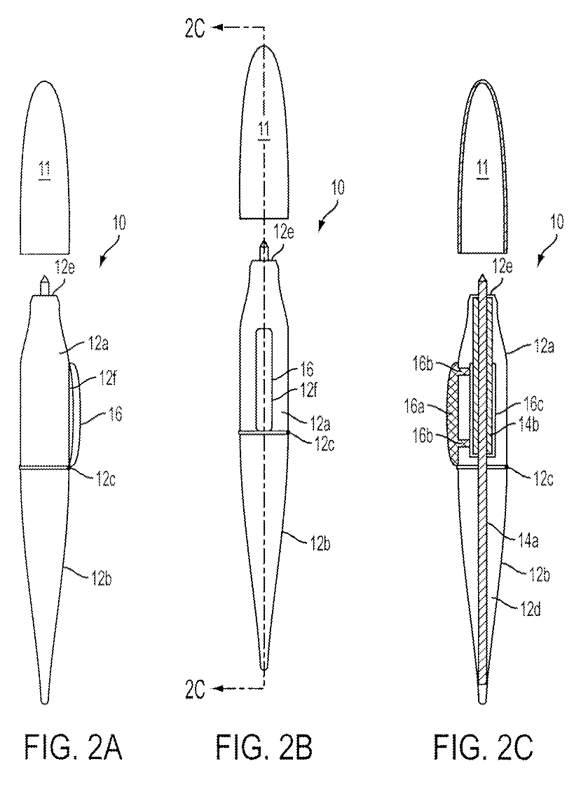

With respect to FIGS. 1 and 2, in a first embodiment of the present invention, a multi-unit cosmetic applicator includes a first cosmetic unit and a second cosmetic unit that is movable with respect to the first cosmetic unit from a stored position to an advanced position via a slide assembly.

Herein, a “stored position” is when the second cosmetic unit is retracted in the housing, while an “advanced position” is when a user accessible portion, of any length, of the second cosmetic unit is extended beyond the housing so that the user can place the cosmetic agent comprised in the cosmetic unit onto their body.

Therein, FIGS. 1a and 1b are front perspective views of a multi-unit cosmetic applicator 10 in accordance with a first embodiment of the invention. FIGS. 2a-2c are, respectively, a right-side view of multi-unit cosmetic applicator 10, a front view of multi-unit cosmetic applicator 10, and a cross-sectional view of multi-unit cosmetic applicator 10 taken along line B-B of FIG. 2b.

Preferably, multi-unit cosmetic applicator 10 is made of plastic, metal, and/or thermoplastic elastomers, rubber, manufactured using blow molding, and assembled by snap-fit assembly. However, any other material, manufacturing, and/or assembly method may be used. Especially desired is to have certain portions of the housing made with anodized plastic materials to give an upscale and refined look.

Multi-unit cosmetic applicator 10 includes a cap 11 and a housing 12. Cap 11 is preferably sized to fit over a substantial portion of an upper housing body 12a that is sealed via a sleeve 12c from a lower housing body 12b.

Lower body 12b comprises an inner space 12d that may be a void space or may be configured as a reservoir for a first cosmetic agent used by a first cosmetic unit 14a. Upper body 12a defines a substantially longitudinal inner space that primarily houses a second cosmetic unit 14b and the means to advance the second cosmetic unit relative to the first.

Housing 12 preferably is designed to have an attractive shape and yet be ergonomically designed to fit in the user's hand. An ergonomic design may include any desired shape that is found to be suitable. As illustrated, lower body 12b may be shaped to taper to a tip while upper housing body 12a has a broader, fuller shape.

Upper housing body 12a includes an opening 12e, suitable for passing both the first cosmetic unit 14a and the second cosmetic unit 14b through such an opening. Opening 12e defines a proximal end of housing 12, while the tip of lower body housing 12b defines a distal end. Upper housing body 12a also includes a substantially longitudinally oriented notch 12f into which a slider assembly 16 is fitted.

First cosmetic unit 14a preferably has a small width to length ratio and reaches well into inner space 12d to wick the first cosmetic agent. For example, cosmetic unit 14a may have a pencil lead shape, one that is substantially cylindrical in cross-section and has a significant length. Therein, cosmetic unit 14a extends the entire length of housing 12 and extends a portion beyond the proximal end of housing 12 to provide a user accessible portion 15a.

In contrast, second cosmetic unit 14b comprises a second cosmetic agent and preferably has greater width to length ratio than the first cosmetic unit 14a. For example, second cosmetic unit 14b has a lipstick shape, one that is substantially cylindrical in cross-section and is relatively shorter than the first cosmetic unit.

Cosmetic unit 14b is disposed about cosmetic unit 14a and, thus, includes longitudinal channel 14c that accommodates the first cosmetic unit 14a. Channel 14c extends longitudinally through the second cosmetic unit 14b and may have any suitable cross-sectional shape that permits the cosmetic unit 14b to move unimpeded relative to the first cosmetic unit. Thus, it should be appreciated that channel 14c includes a peripheral clearance about cosmetic unit 14a.

Using the slider assembly (to be taught hereinafter), the second cosmetic unit is selectably moved relative to the first cosmetic unit from a stored position in housing 12 (FIG. 1a) so that a user accessible portion 15b, of any length, of the second cosmetic unit 14b extends beyond the distal end of the housing (FIG. 1b).

Therein, for example, cosmetic unit 14a may be a lip liner, which has a diameter significantly smaller than the second cosmetic unit 14b, such as a lip gloss. The first cosmetic units may be a solid, semi-solid or waxy product such as an eye pencil, eye liner, mascara, lipstick, lip liner, lip balm, brow definer, concealer, foundation, blush, etc.

To move the second cosmetic unit, multi-unit cosmetic applicator 10 includes a slider assembly 16. Slider 16 may include a button 16a having a textured surface to provide a tactile response to the user. Slider assembly 16 includes spaced apart arms 16b that connect to a sleeve 16c that retains the second cosmetic unit. Sleeve 16c preferable includes a transverse floor that has an opening of a size suitable for permitting the movement of the second cosmetic unit relative to the first.

When the user pushes slider assembly 16 via button 16a, longitudinally towards the opening and the housing 12d, the second cosmetic unit 14 advances through the opening 12d and a portion 15b is suitably located for a user.

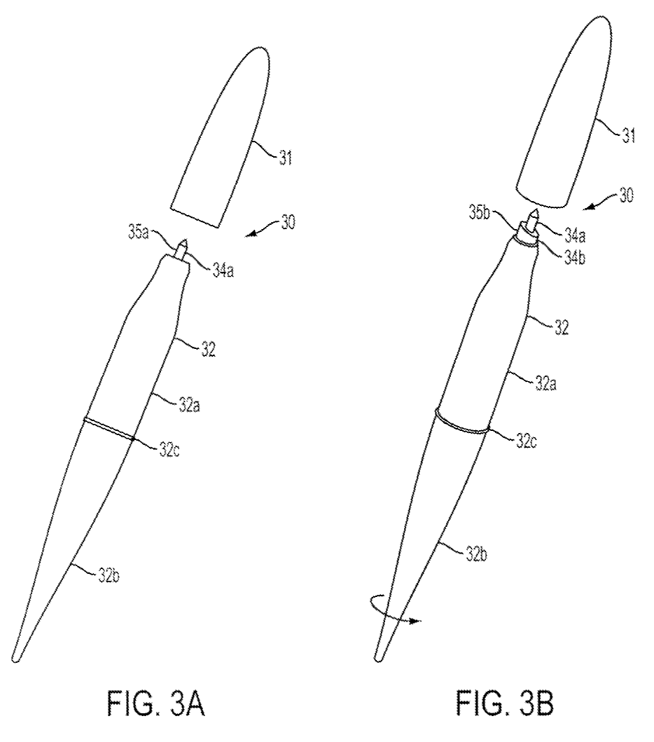

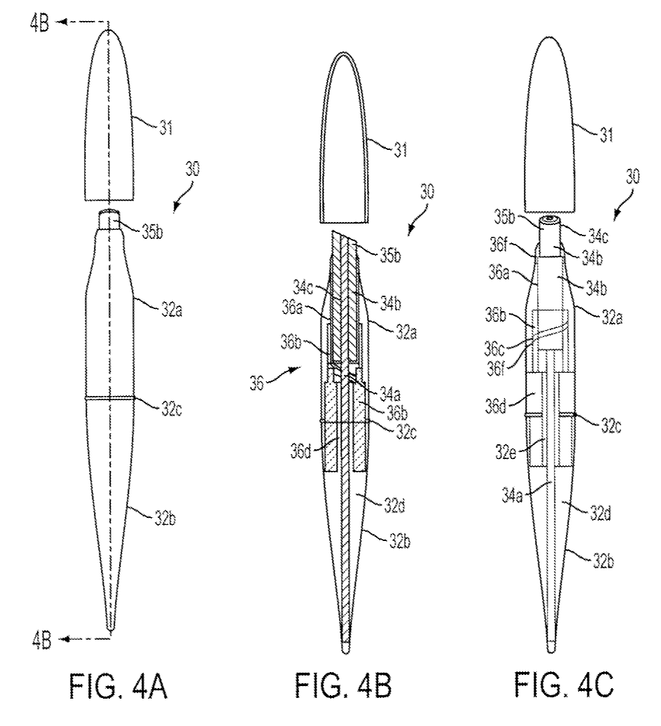

With respect to FIGS. 3 and 4, in a second embodiment of the present invention, a multi-unit cosmetic applicator includes a first housing portion that rotates relative to a second housing portion and advances a second cosmetic agent relative to a first cosmetic agent from a stored position to an advanced position.

Therein, FIGS. 3a and 3b are perspective views of a multi-unit cosmetic applicator 30 in accordance with the second embodiment of the invention. FIGS. 4a-4c are, respectively, a front view of cosmetic applicator 30 in an advanced position, a cross-sectional view of cosmetic applicator 30 taken along line A-A of FIG. 4a, and a see-through view of cosmetic applicator 30 in an advanced position.

Preferably, multi-unit cosmetic applicator 30 is made of plastic, metal, and/or thermoplastic elastomers, rubber, manufactured using blow molding, and assembled by snap-fit assembly. However, any other material, manufacturing, and/or assembly method may be used. Especially desired is to have certain portions of the housing made with anodized plastic materials to give an upscale and refined look.

Therein, cosmetic applicator 30 includes a cap 31 and a housing 32. Cap 31 is preferably sized to fit over a substantial portion over an upper housing body 32a that is sealed via a sleeve 32c from a lower body 32b.

Lower housing body 32b comprises an inner space 32d which may be configured as a void space or a reservoir for a first cosmetic agent used by a first cosmetic unit 34a. Upper body 32a defines a substantially longitudinal inner space that primarily houses a second cosmetic unit 34b and the means to advance the second cosmetic unit relative to the first.

Similar to multi-unit cosmetic applicator 10, herein, the first cosmetic unit 34a preferably has a small width to length ratio and reaches well into inner space 32d to wick the first cosmetic agent. For example, cosmetic unit 14a may have a pencil lead shape, one that is substantially cylindrical in cross-section and has a significant length. Therein, cosmetic unit 34a extends the entire length of housing 32 and extends a portion beyond the proximal end of housing 32 to provide a user accessible portion 35a.

In contrast, second cosmetic unit 34b comprises a second cosmetic agent and preferably has greater width to length ratio than the first cosmetic unit 34a. For example, second cosmetic unit 34b has a lipstick shape, one that is substantially cylindrical in cross-section and is relatively shorter than the first cosmetic unit.

Cosmetic unit 34b is disposed about cosmetic unit 34a and, thus, includes longitudinal channel 34c that accommodates the first cosmetic unit 34a. Channel 34c extends longitudinally through the second cosmetic unit 34b and may have any suitable cross-sectional shape that permits the cosmetic unit 34b to move unimpeded relative to the first cosmetic unit. Thus, it should be appreciated that channel 34c includes a peripheral clearance about cosmetic unit 34a. In one embodiment, cosmetic unit 34a is anchored at a distal end of body 32b.

Using the twist assembly (to be taught hereinafter), the second cosmetic unit is selectably moved relative to the first cosmetic unit from a stored position in housing 32 (FIG. 3a) so that a user accessible portion 35b, of any length, of the second cosmetic unit 14b extends beyond the distal end of the housing (FIG. 3b).

Therein, for example, cosmetic unit 34a may be a lip liner, which has a diameter significantly smaller than the second cosmetic unit 34b, such as a lip gloss. The first cosmetic units may be a solid, semi-solid or waxy product such as an eye pencil, eye liner, mascara, lipstick, lip liner, lip balm, brow definer, concealer, foundation, blush, etc.

To move the second cosmetic unit, multi-unit cosmetic applicator 30 includes a twist assembly 36. Twist assembly 36 includes a sleeve 36a that houses the second cosmetic unit 34b and a plug 36b configured to include a helical guide 36c and cylinder 36d having a channel 36e.

An upper portion of plug 36b fits within the upper housing body 32a while a lower portion comprising approximately half of cylinder 36c is disposed in lower housing body 32b. Therein, body 32b is rotatable with respect to body 32a and rotates with twist assembly 36. Thus, in essence, the lower portion of the cosmetic applicator rotates, while the upper portion of the body is still and the cosmetic unit is advanced longitudinally.

Sleeve 36a further includes spaced-apart pins 36f that travel in guide 36c and is keyed to body 32a in an inner peripheral groove disposed on body 32a. Guide 36c is disposed in the interior surface of the sleeve and is shaped to have a helical surface. By rotating lower housing body 32b, the sleeve twists and moves with respect to the axis of multi-unit applicator 30.

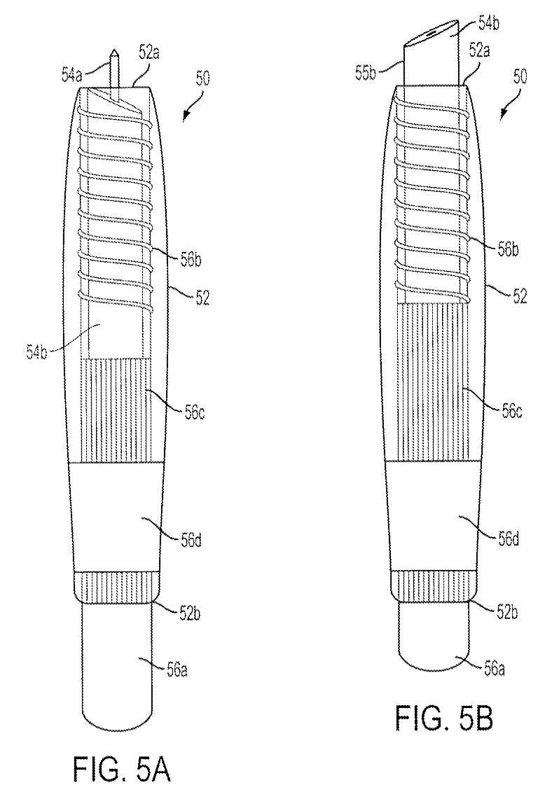

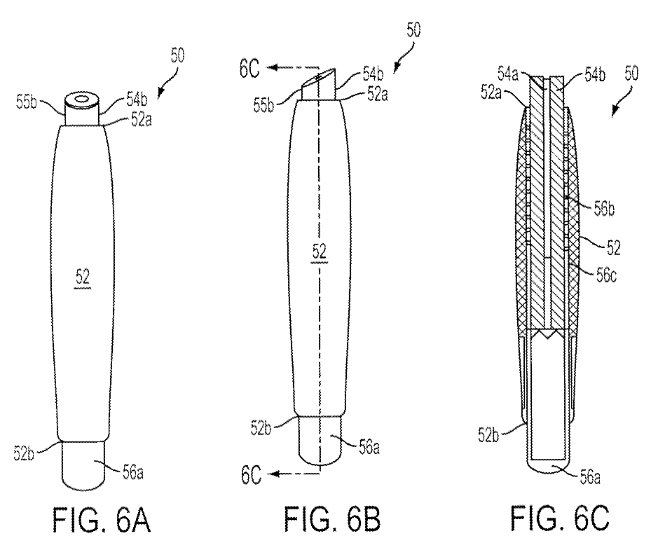

With respect to FIGS. 5 and 6, in a third embodiment of the present invention, a multi-unit cosmetic applicator includes a first cosmetic unit and a second cosmetic unit that is movable with respect to the first cosmetic unit from a stored position to an advanced position via a push button and spring assembly.

Therein, FIGS. 5a and 5b are front perspective views of multi-unit cosmetic applicator 50 in accordance with one embodiment of the invention wherein certain portions of the housing are shown translucent. FIGS. 6a-6c are, respectively, a right-side view of multi-unit cosmetic applicator 50, a front view of multi-unit cosmetic applicator 10, and a cross-sectional view of multi-unit cosmetic applicator 50 taken along line A-A of FIG. 6b.

Preferably, multi-unit cosmetic applicator 50 is made of plastic, metal, and/or thermoplastic elastomers, rubber, manufactured using blow molding, and assembled by snap-fit assembly. However, any other material, manufacturing, and/or assembly method may be used. Especially desired is to have certain portions of the housing made with anodized plastic materials to give an upscale and refined look.

Multi-unit cosmetic applicator 50 may include a cap not shown and a housing 52. The cap if provided is preferably sized to fit over a substantial portion of an upper portion of housing 52.

The housing defines a substantially longitudinal inner space that houses a first cosmetic unit 54a, a second cosmetic unit 54b, a spring that in conjunction with a push button advance the second cosmetic unit relative to the first cosmetic unit.

Housing 52 preferably is designed to have an attractive shape and yet be ergonomically designed to fit in the user's hand. An ergonomic design may include any desired shape that is found to be suitable.

Housing 52 comprises a proximal opening 52a suitable for passing both the first cosmetic unit 54a and the second cosmetic unit 54b through such an opening and a distal opening 52b wherein a push button (to be taught hereinafter) is disposed.

First cosmetic unit 54a preferably has a small width to length ratio and is anchored at distal opening 52b. For example, cosmetic unit 54a may have a pencil lead shape, one that is substantially cylindrical in cross-section and has a significant length. Therein, cosmetic unit 54a extends a portion of the length of housing.

In contrast, second cosmetic unit 54b comprises a second cosmetic agent and preferably has greater width to length ratio than the first cosmetic unit 54a. For example, second cosmetic unit 54b has a lipstick shape, one that is substantially cylindrical in cross-section and is relatively shorter than the first cosmetic unit.

Cosmetic unit 54b is disposed about cosmetic unit 54a and, thus, includes longitudinal channel 54c that accommodates the first cosmetic unit 54a. Channel 54c extends longitudinally through the second cosmetic unit 54b and may have any suitable cross-sectional shape that permits the cosmetic unit 54b to move unimpeded relative to the first cosmetic unit. Thus, it should be appreciated that channel 54c includes a peripheral clearance about cosmetic unit 54a.

Using the push button and spring (to be taught hereinafter), the second cosmetic unit is selectably moved relative to the first cosmetic unit from a stored position in housing 52 (FIG. 5a) so that a user accessible portion 55b, of any length, of the second cosmetic unit 54b extends beyond the distal end of the housing (FIG. 5b).

Therein, for example, cosmetic unit 54a may be a lip liner, which has a diameter significantly smaller than the second cosmetic unit 54b, such as a lip gloss. The first cosmetic units may be a solid, semi-solid or waxy product such as an eye pencil, eye liner, mascara, lipstick, lip liner, lip balm, brow definer, concealer, foundation, blush, etc.

To move the second cosmetic unit, multi-unit cosmetic applicator 50 includes a push button 56a, a spring 56b, and a sleeve 56c. Spring 56b is biased against sleeve 56c. Sleeve 56c is substantially cylindrical and retains a lower portion of second cosmetic unit 54b. Push button 56a is biased against the sleeve at a lower edge of the sleeve or is integral with the sleeve, while spring 56b is biased against the sleeve at an upper edge of the sleeve. Spring 56a is biased at a proximal edge against a peripheral rim of opening 52a. A substantially cylindrical guide 56d is retained in a lower part of housing 52 to limit the travel of the push button by engaging a proximal protrusion of the push button.

When the push button is depressed by the user, the second cosmetic unit moves relative to the first cosmetic unit via push button means as are known for example in a pen.

With regard to the embodiments of FIGS. 1-6, the first cosmetic unit, inner unit, comprises and delivers a liquid cosmetic agent. The liquid cosmetic agent may be, but is not limited, to skin treatment serums, lotions, solutions, sunscreen preparations, self-tanning preparations, color enhancing preparations, shine enhancing preparations, preparations that include film formers to improve wear resistant attributes, perspiration and moisture resistance properties; a rubefacient, cosmetics colorants, optical brighteners, glitter or fluorescent materials as desired for additional visual effects.

To do so, the cosmetic unit may comprise suitable natural and synthetic substrate materials that include, but are not limited, to cotton, flax, silk or polyesters, rayons, acrylics, acetates, triacetates, polyolefins, and lyocells. Such substrate materials can be impregnated with the liquid cosmetic agent for subsequent delivery during use of the first cosmetic unit. Preferred are highly absorbent substrate materials.

In one or more embodiments related to the embodiments of FIGS. 1-6, the first cosmetic unit, inner unit, rather than comprising and delivering a liquid cosmetic agent comprises and delivers a solid, semi-solid, or waxy cosmetic agent. Therein, each of the embodiments comprises a take-up mechanism that maintains a sufficient user accessible portion 15a, 35a, or 55a of the cosmetic unit external to the housing.

Such a take up mechanism may be automatic such as a spring assembly or a manually where the user engages the first cosmetic unit and advances it forward.

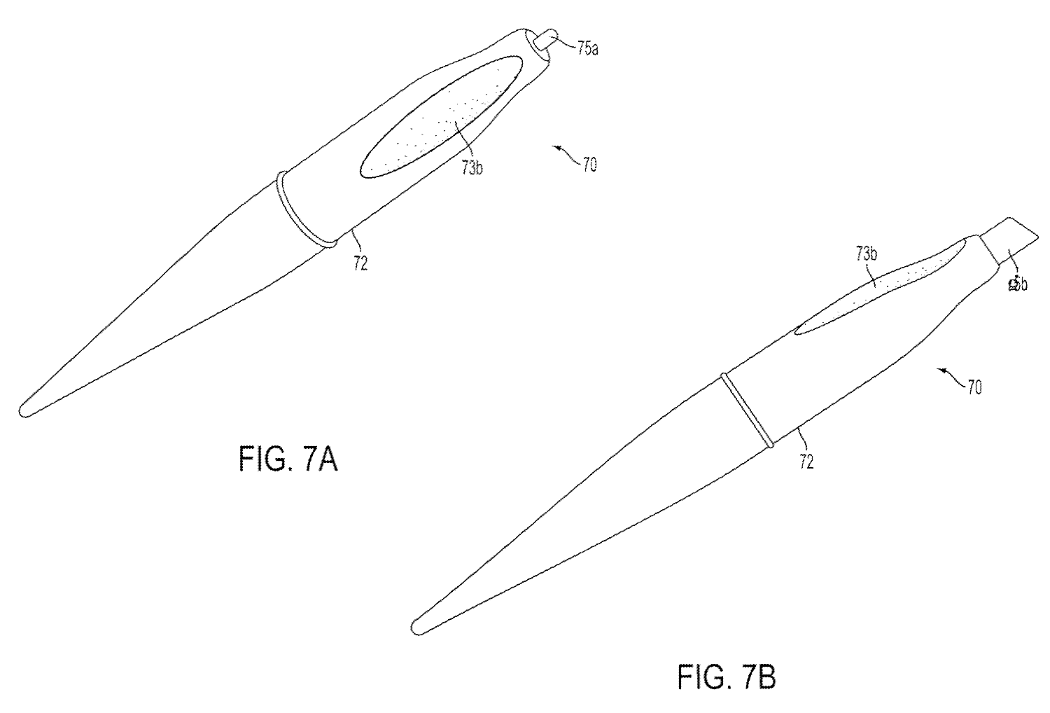

In one or more embodiments related to the embodiments of FIGS. 1-6 or unrelated thereto, an outer cosmetic unit may comprise and deliver a liquid cosmetic agent. Thus, FIGS. 7-9 illustrate a fourth embodiment of a multi-unit cosmetic applicator in accordance with one embodiment of the present invention.

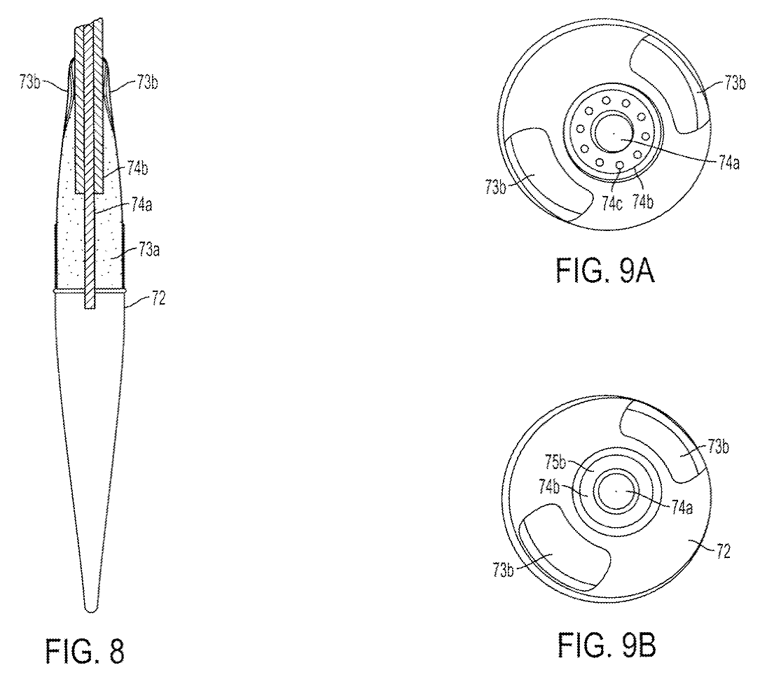

Therein, FIGS. 7a and 7b are front perspective views of multi-unit cosmetic applicator 70 in accordance with one embodiment of the invention. FIG. 8 is a cross-sectional view of the multi-unit cosmetic applicator thereof and FIGS. 9a and 9b are top perspective view thereof.

Multi-unit cosmetic applicator 70 may be constructed substantially in the same manner as taught with respect to any of the foregoing embodiments and having means to advance the second cosmetic unit, herein cosmetic unit 74b, relative to a first cosmetic unit, herein cosmetic unit 74a. The units are sized to substantially permit movement of the second cosmetic unit 74b relative to the first and advance a user accessible portion 75b external to housing 72 to deliver a second cosmetic agent. When the second cosmetic unit 74b is stored, a user accessible portion 75a of cosmetic unit 74a is external to the housing to deliver a first cosmetic agent.

Housing 72 preferably includes inner space 73a which may be a void space or may be usable as a reservoir for the second cosmetic agent. Therein, inner space 73a is preferably sealed from any other reservoir. One or more flexible housing portions 73b are disposed in fluid communication with inner space 73a to infuse the second cosmetic unit with the second cosmetic agent.

To permit advantageous delivery of the cosmetic agent at a proximal surface of cosmetic unit 74b, a plurality of apertures 74c (FIG. 9a) as opposed to a smooth surface (FIG. 9b). Each of the cosmetic units may vary in size to allow for controlled application to varying areas and to allow for variable dosage or step treatments.

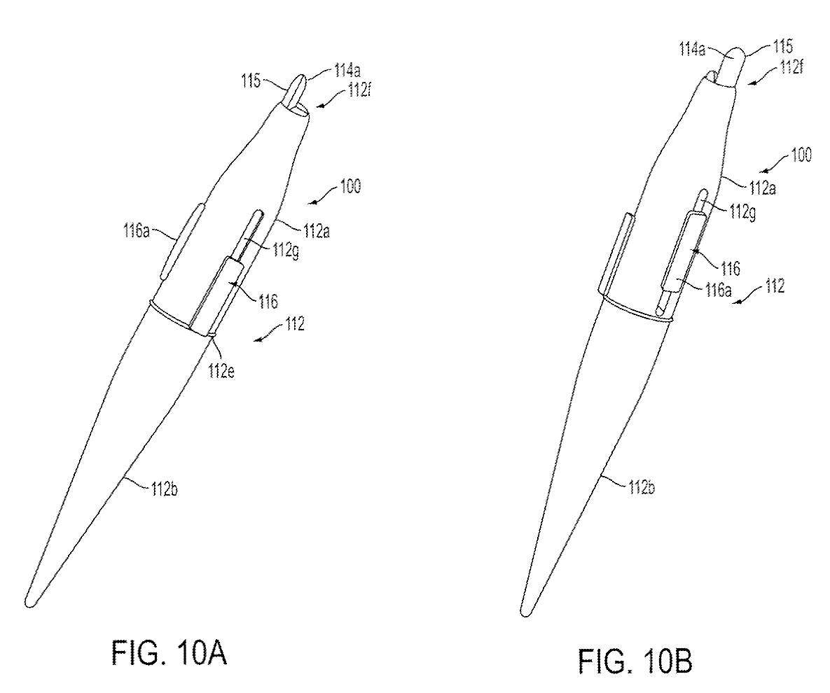

With respect to FIGS. 10, 11, and 12, in a further embodiment of the present invention, a multi-unit cosmetic applicator includes a first, second, and third cosmetic unit that are movable with respect to each other and the housing from a stored position to an advanced position via one or more slide assemblies.

Herein, a “stored position” is when a cosmetic unit is retracted in the housing, while an “advanced position” is when a user accessible portion, of any length, of the second cosmetic unit is extended beyond the housing so that the user can place the cosmetic agent comprised in the cosmetic unit onto their body.

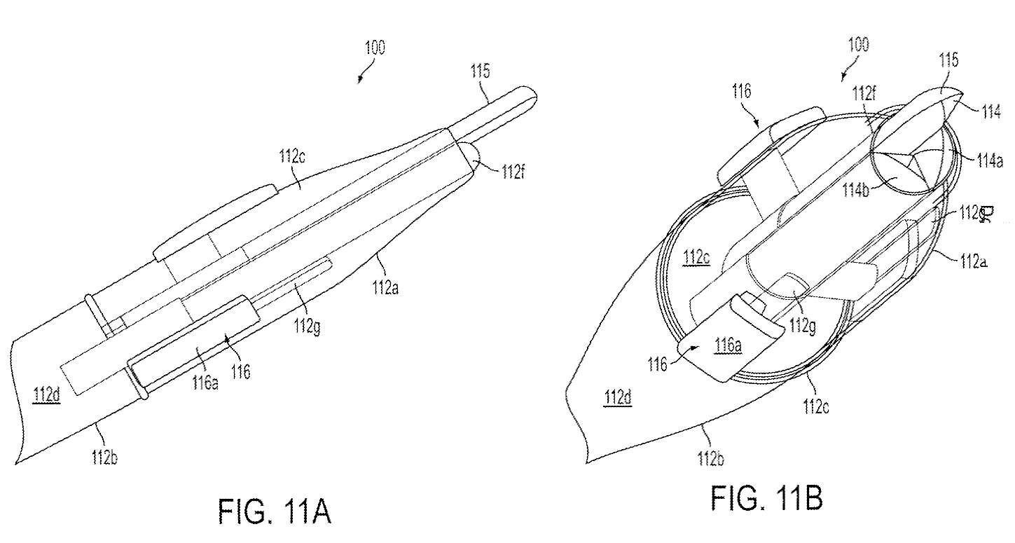

Although, the embodiment of FIGS. 10, 11 , and 12 are illustrated with respect to three cosmetic units, limiting the number of cosmetic units and means to advance the cosmetic units to two or increasing the number of cosmetic units and means to advance the cosmetic units to four (4) or greater is also encompassed by the present embodiment.

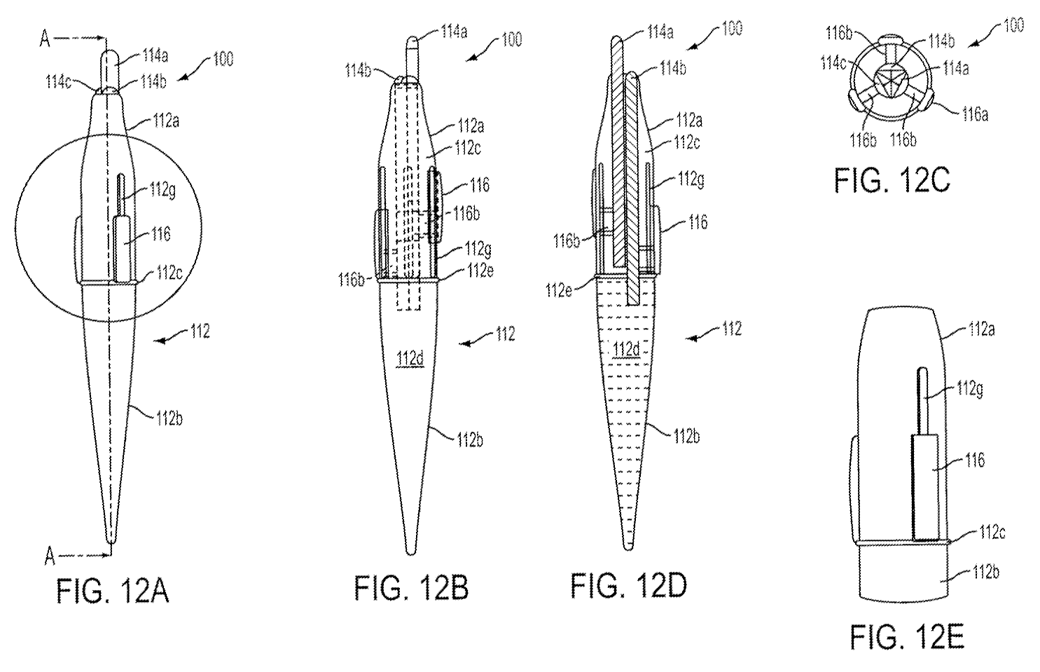

Therein, FIGS. 10a and 10b are, respectively, a right-side perspective view and a left-side perspective view, as of a multi-unit cosmetic applicator 100 in accordance with a further embodiment of the invention. FIGS. 11a and 11b are, respectively, a partial see-through side view view and front perspective view of multi-unit cosmetic applicator 100. FIGS. 12a-12e are, respectively, a right-side view of multi-unit cosmetic applicator 100, a side partial see-through view of multi-unit cosmetic applicator 100, a top partial see-through view of multi-unit cosmetic applicator 100, a cross-sectional view of dual cosmetic applicator 100 taken along line A-A of FIG. 12a, and a partial see-through view of a detail of area B of FIG. 12a.

Preferably, multi-unit cosmetic applicator 100 is made of plastic, metal, and/or thermoplastic elastomers, rubber, manufactured using blow molding, and assembled by snap-fit assembly. However, any other material, manufacturing, and/or assembly method may be used. Especially desired is to have certain portions of the housing made with anodized plastic materials to give an upscale and refined look.

Multi-unit cosmetic applicator 100 includes a housing 112 having an upper body 112a and a lower body 112b that are fixedly or removably joined by any known means. Upper body 112a defines a substantially longitudinal inner space 112c for one or more slider assemblies and cosmetic units. Lower body 112b comprises an inner space 112d configured to receive a portion of one or more cosmetic units when in a stored position.

Inner space 112d may be a void space or may also comprise one or more reservoirs that may each house a different cosmetic agent or the same cosmetic agent such as one taught in this application. If the cosmetic agent is fluid one or more reservoirs may be in fluid communication with one or more corresponding cosmetic units.

Housing 112 preferably is designed to have an attractive shape and yet be ergonomically designed to fit in the user's hand. An ergonomic design may include any desired shape that is found to be suitable. As illustrated, lower body 112b may be shaped to taper to a tip while upper housing body 112a has a broader, fuller shape. The upper and lower body may be joined together via a ring portion 112e.

Upper housing body 112a includes an opening 112f, suitable for passing a first cosmetic unit 114a, a second cosmetic unit 114b, and third cosmetic unit 114c through such an opening. Opening 112f defines a proximal end of housing 112, while the tip of lower body housing 112b defines a distal end. Upper housing body 112a also includes substantially one or more longitudinally oriented notches 112g into which a corresponding slider assembly 116 (to be taught hereinafter) are fitted.

Each of three cosmetic units has a substantially longitudinal shape that when in a stored position extends from a proximal end of housing 112 through inner space 112c into inner space 112d at the distal end of the cosmetic unit. In cross-section, each cosmetic unit may have any shape. It may be preferred for each cosmetic unit to represent portion of a larger unit; for example, a segment of a circle or a portion of a triangle. To permit unimpeded independent movement; each cosmetic unit is laterally spaced-apart from another. Thus, it should be appreciated that opening 112f includes a peripheral clearance to permit movement of the cosmetic units.

Using the slider assembly (to be taught hereinafter), each cosmetic unit is selectably moved relative to the other cosmetic units from a stored position in housing 112 so that a user accessible portion 115, of any length, of one or more cosmetic units extends beyond the distal end of the housing. When in an advanced position, each of the cosmetic units extends a portion beyond the proximal end of housing 112 to provide a respective user accessible portion 115.

To move the cosmetic units, multi-unit cosmetic applicator 100 includes one or more slide assembly 116. Each slide assembly 116 may include a button 116a having a textured surface to provide a tactile response to the user. Each slide assembly 116 includes an arm 116b that connects to a sleeve 116c to retain one of the cosmetic units.

When the user pushes slide assembly 116 via button 116a, longitudinally towards the opening and the housing, the respective cosmetic unit advances through the opening 112f and a portion 115 is suitably located for a user.

The following patents and patent publications are hereby incorporated by reference for all purposes:

U.S. Patent Publication 2005/0100388

U.S. Pat. No. 6,543,458; U.S. Pat. No. 6,497,524.

What is claimed is:

1. A multi-unit cosmetic applicator comprising:
a housing body,
a first cosmetic unit housed in the housing body,
a second cosmetic unit housed in the housing body,
an opening in the housing,
wherein each cosmetic unit has a means for being independently movable relative to each other from a stored position to an advanced position and back to its stored position.

2. The multi-unit cosmetic applicator of claim 1, wherein the cosmetic units move together.

3. The multi-unit cosmetic applicator of claim 1, wherein one of the cosmetic units is stationary when the other cosmetic unit is moving.

4. The multi-unit cosmetic applicator of claim 1, wherein said means is a slider assembly housed in the housing body to move one of the first and second cosmetic units.

5. The multi-unit cosmetic applicator of claim 1, wherein said means is a slider assembly housed in the housing body to move each of the first and second cosmetic units independent of each other.

6. The multi-unit cosmetic applicator of claim 1, wherein said means is a twist assembly housed in the housing body to move one of the first and second cosmetic units.

7. The multi-unit cosmetic applicator of claim 1, wherein said means is a twist assembly housed in the housing body to move each of the first and second cosmetic units independent of each other.

8. The multi-unit cosmetic applicator of claim 1, wherein said means is a push button and spring assembly housed in the housing body to move one of the first and second cosmetic units.

9. The multi-unit cosmetic applicator of claim 1, wherein said means is a push button and spring assembly housed in the housing body to move each of the first and second cosmetic units independent of each other.

10. The multi-unit cosmetic applicator of claim 1, wherein one of the first and second cosmetic units is disposed interior of the respective other of the first and second cosmetic unit.

11. The multi-unit cosmetic applicator of claim 1, wherein one of the first and second cosmetic units comprises a channel, the respective other of the first and second cosmetic unit being disposed in the channel.

12. The multi-unit cosmetic applicator of claim 1, wherein one of the first and second cosmetic units is disposed adjacent to the respective other of the first and second cosmetic unit.

13. The multi-unit cosmetic applicator of claim 1, wherein the structure of one of the first and second cosmetic units comprises a reservoir.

14. The multi-unit cosmetic applicator of claim 1, wherein the reservoir is housed in a lower portion of the housing.

15. The multi-unit cosmetic applicator of claim 1, wherein the one of the first and second cosmetic units reservoir extends the length of the housing.

16. The multi-unit cosmetic applicator of claim 1 wherein the one of the first and second cosmetic units with the reservoir comprises a length greater than a length of the respective other of the first and second cosmetic units for reaching the reservoir.

17. The multi-unit cosmetic applicator of claim 1, wherein at least one of the first and second cosmetic units structure comprises a wicking substrate.

18. The multi-unit cosmetic applicator of claim 22, wherein the wicking substrate comprises one of cotton, flax, silk, polyester, rayon, and acrylic.

19. The multi-unit cosmetic applicator of claim 1, wherein each of the first and second cosmetic units contains a cosmetic agent, each of the cosmetic agents having a functionally different property from the other cosmetic agent.

20. The multi-unit cosmetic applicator of claim 1, wherein the housing comprises a lower housing portion and an upper housing portion, the lower housing portion being rotatable with respect to the upper housing portion.

21. The multi-unit cosmetic applicator of claim 1, wherein each cosmetic unit contains a cosmetic agent, the cosmetic agent of the cosmetic unit comprising one of an eye pencil, an eye liner, a mascara, a lipstick, a lip liner, a lip balm, blush, foundation, a brow definer, and a concealer, a skin treatment, a serum, a lotion, a solution, a sunscreen preparation, a self-tanning preparation, a color enhancing preparation.

22. The multi-unit cosmetic applicator of claim 21, wherein the cosmetic agent of the cosmetic unit further comprises a shine enhancing property, an anti-aging property, a film forming property, a preparation that include perspiration resistant properties or a preparation that has moisture enhancing properties.

23. The multi-unit cosmetic applicator of claim 1, wherein each of the first and second cosmetic units contains a cosmetic agent, the cosmetic agents each independently comprising one of a solid, semi-solid, gel, liquid and waxy structure.

24. A multi-unit cosmetic applicator comprising:
a housing,
a plurality of cosmetic units,
an opening in the housing,
a means for independently advancing one of the plurality of cosmetic units relative to another of the plurality of cosmetic units independently, relative to each other from a stored position to an advanced position and back to its stored position.

25. The multi-unit cosmetic applicator of claim 24, wherein the cosmetic units move together.

26. The multi-unit cosmetic applicator of claim 24, wherein at least one of the cosmetic units is stationary when the other cosmetic units are moving.

27. The multi-unit cosmetic applicator of claim 24, wherein said means is a slider assembly housed in the housing body to move at least one of the plurality of cosmetic units.

28. The multi-unit cosmetic applicator of claim 24, wherein said means is a slider assembly housed in the housing body to move the cosmetic units independent of each other.

29. The multi-unit cosmetic applicator of claim 24, wherein said means is a twist assembly housed in the housing body to move one of the cosmetic units.

30. The multi-unit cosmetic applicator of claim 24, wherein said means is a twist assembly housed in the housing body to move each of the cosmetic units independent of each other.

31. The multi-unit cosmetic applicator of claim 24, wherein said means is a push button and spring assembly housed in the housing body to move one of the first and second cosmetic units.

32. The multi-unit cosmetic applicator of claim 24, wherein said means is a push button and spring assembly housed in the housing body to move each of the cosmetic units independent of each other.

33. The multi-unit cosmetic applicator of claim 24, wherein one of the cosmetic units is disposed interior of the respective other of the cosmetic units.

34. The multi-unit cosmetic applicator of claim 24, wherein at least one of the cosmetic units comprises a channel, wherein at least one of the respective other of the cosmetic unit being disposed in the channel.

35. The multi-unit cosmetic applicator of claim 24, wherein the cosmetic units are disposed adjacent to the respective other of the cosmetic units.

36. The multi-unit cosmetic applicator of claim 24, wherein the structure of at least one of the cosmetic units comprises a reservoir.

37. The multi-unit cosmetic applicator of claim 24, wherein the reservoir is housed in a lower portion of the housing.

38. The multi-unit cosmetic applicator of claim 24, wherein the one of the cosmetic units reservoir extends the length of the housing.

39. The multi-unit cosmetic applicator of claim 24, wherein the at least one of the cosmetic units with the reservoir comprises a length greater than a length of the respective other of the cosmetic units for reaching the reservoir.

40. The multi-unit cosmetic applicator of claim 24, wherein at least one of the cosmetic units structure comprises a wicking substrate.

41. The multi-unit cosmetic applicator of claim 24, wherein the wicking substrate comprises one of cotton, flax, silk, polyester, rayon, and acrylic.

42. The multi-unit cosmetic applicator of claim 24, wherein each of the plurality of cosmetic agents has a functionally different property from another one of the plurality of cosmetic agents.

43. The multi-unit cosmetic applicator of claim 24, wherein the housing comprises a lower housing portion and an upper housing portion, the lower housing portion being rotatable with respect to the upper housing portion.

44. The multi-unit cosmetic applicator of claim 24, wherein each of the cosmetic units comprises a cosmetic agent, the cosmetic agents of the cosmetic units each independently comprises one of an eye pencil, an eye liner, a mascara, a lipstick, a lip liner, a lip balm, blush, foundation, a brow definer, and a concealer, a skin treatment, a serum, a lotion, a solution, a sunscreen preparation, a self-tanning preparation, a color enhancing preparation.

45. The multi-unit cosmetic applicator of claim 44, wherein the cosmetic agent of the cosmetic unit each independently further comprises a shine enhancing property, an anti-aging property, a film forming property, a preparation that include perspiration resistant properties or a preparation that has moisture enhancing properties.

46. The multi-unit cosmetic applicator of claim 24, wherein each of the cosmetic units comprises a cosmetic agent, the cosmetic agent of the cosmetic unit each independently comprising one of a solid, semi-solid, gel, liquid and waxy structure.

47. A multi-unit cosmetic applicator comprising:
a housing with an opening,
a plurality of cosmetic units housed in the housing in a stored state,
a means for independently advancing each of the plurality of cosmetic units through the opening to put the one of the plurality of cosmetic units in an advanced state for contacting a body of a user.

48. An assembly for an applicator, the assembly comprising:
a plurality of cosmetic units independently movable with respect to each other from a stored position to an advanced position in the same direction to place the cosmetic unit in contact with a body of the user,
a means for moving at least one of the plurality of cosmetic units.

49. An applicator held in a hand of a user, the applicator comprising
a housing ergonomic to the hand to place an opening of the housing in convenient reach of a face portion of the user;
a plurality of cosmetic units independently movable with respect to each other;
a means for moving at least one of the plurality of cosmetic units through the opening; and
a user interface for initiating the means for moving one of the plurality of cosmetic units,

50. A method of delivering a plurality of cosmetic agents, the method comprising the steps of:
supplying a cosmetic applicator, the applicator comprising
a housing body,
a first cosmetic unit housed in the housing body,
a second cosmetic unit housed in the housing body, the second cosmetic unit independently movable relative to the first cosmetic unit, and
a means for independently moving the second cosmetic unit relative to the first cosmetic unit;
initiating the means for moving the second cosmetic unit;
advancing the second cosmetic unit through an opening in the housing body to place the second cosmetic unit in contact with a portion of the user's body.
